(19) United States
(12) Patent Application Publication
(10) Pub. No.: US 2013/0049239 A1
(43) Pub. Date: Feb. 28, 2013

(54) LENS FABRICATION APPARATUS AND LENS FABRICATION METHOD USING THE SAME

(71) Applicant: Cheol Jun YOO, Cheonan (KR)

(72) Inventor: Cheol Jun YOO, Cheonan (KR)

(21) Appl. No.: 13/599,714

(22) Filed: Aug. 30, 2012

(30) Foreign Application Priority Data
Aug. 30, 2011 (KR) 10-2011-0086827

(51) Int. Cl. G02B 1/12; B29C 45/34

(52) U.S. Cl. 264/1.36; 425/174.4

(57) ABSTRACT

A lens fabrication apparatus includes: a lens mold having a connection portion formed on one side thereof and disposed on a light emission surface of a light emitting unit; and a vacuum forming unit discharging air from within the lens mold to the outside through the connection portion or injecting a material into the lens mold through the connection portion.

### CROSS-REFERENCE TO RELATED APPLICATIONS

This application claims the priority of Korean Patent Application No. 10-2011-0086827 filed on Aug. 30, 2011, in the Korean Intellectual Property Office, the disclosure of which is incorporated herein by reference.

### BACKGROUND OF THE INVENTION

1. Field of the Invention

The present invention relates to a lens fabrication apparatus and a lens fabrication method using the same.

2. Description of the Related Art

In general, light emitting devices are fabricated in the form of a package including (one or more) light emitting diodes (LEDs) mounted therein, and LED packages are generally fabricated by using a substrate or a reflector pre-mold.

Here, in order to cover the LEDs to protect them and to enhance the optical characteristics of the packages, e.g., to increase light emission efficiency within a certain orientation angle, an optical unit, such as a lens, or the like, is provided in an upper portion of an LED package.

Such a lens may be fabricated in advance through casting, or the like, and may then be coupled to the LED package by means of an adhesive. However, the coupling using the adhesion method may have a problem, in which dimensional accuracy may be degraded due to weak adhesive strength between the lens and the package.

Also, according to the adhesion method, the package and the lens are substantially bonded while exposed in the air, therefore making it impossible to avoid the generation of voids in the molded lens.

Thus, recently, a transfer molding technique of fabricating a lens by directly forming a molding member in the form of a lens on a package with a resin material such as epoxy, silicon, or the like, has commonly been used.

However, in the related art transfer molding technique, in the process of fabricating a lens, an air exhaust is stopped up by a molding material filled in an inner space of a lens mold before air within the lens mold is completely discharged to the outside.

Thus, the lens having a molding member shape is formed with gas partially remaining in the inner space of the lens mold.

A flow of the molding material when filling the lens mold is not always uniform.

Namely, due to the irregular flow of the molding material filling the lens mold, and a phenomenon in which air is drawn into a gap between an injection nozzle and the lens mold, air is captured within the molding material, resulting in a failure to prevent the generation of voids.

The presence of voids brings about defective hardening of the molding material filling the lens mold, and causes a direct reduction in both the uniformity of light emitted through a completed lens and light efficiency.

### SUMMARY OF THE INVENTION

An aspect of the present invention provides a lens fabrication apparatus capable of enhancing dimensional accuracy of a lens shape and minimizing a generation of voids in a lens while reducing a fabrication time and fabrication costs, and a lens fabrication method using the same.

According to an aspect of the present invention, there is provided a lens fabrication apparatus including: a lens mold having a connection portion formed on one side thereof and disposed on a light emission surface of a light emitting unit; and a vacuum forming unit discharging air from within the lens mold to the outside through the connection portion or injecting a material into the lens mold through the connection portion.

One connection portion may be provided.

The vacuum forming unit may include: a body unit having an air discharge portion with one end communicating with the connection portion; and a material supply unit installed within the body unit.

The air discharge portion may be an air passage formed within the body unit, and an entrance communicating with the connection portion and at least one exit opened to the outer side of the body unit may be provided at both ends of the air passage.

The air passage may include an annular passage having the exit and formed between an inner circumferential surface of the body unit and an outer circumferential surface of the material supply unit; and at least one connection passage connecting the entrance and the annular passage.

The connection portion may be a protrusion having a hollow portion, and the protrusion may be inserted into the air discharge portion to be coupled thereto.

An O-ring may be installed on an outer circumferential surface of the protrusion.

The connection portion may be a protrusion having a hollow portion, and one end portion of the body unit may be inserted into the hollow portion to be coupled thereto.

An O-ring may be installed on an outer circumferential surface of the one end portion of the body unit.

The hollow portion of the connection portion may be formed to be tapered.

The lens fabrication apparatus may further include a moving unit moving the material supply unit to connect the material supply unit to the connection portion.

The moving unit may include a pair of rollers disposed to be spaced apart at a rear side of the material supply unit; a belt installed to be rotatable by the pair of rollers; and a support having one end connected with the material supply unit and disposed on the belt.

The support may be a driving motor, and a transfer screw may be provided within the material supply unit such that the transfer screw is connected to a shaft of the driving motor.

The moving unit may be a cylindrical device having a rod with one end connected with a rear portion of the material supply unit.

The lens mold may include a central convex portion; and a flat portion formed in the circumferential surface of a lower end of the convex portion.

At least one excessive material accommodation recess may be formed in an inner circumferential surface of the lens mold.

The lens fabrication apparatus may further include a suction pump connected to the air discharge portion.

The air discharge portion and the suction pump may be connected by a connection member.

The lens fabrication apparatus may further include: at least one air inflow restricting recess formed in an inner circumferential surface of the body unit; and at least one O-ring installed on an outer circumferential surface of the material supply unit at a position of the air inflow restricting recess.

A lubricant layer may be provided in the air inflow restricting recess.

The lens fabrication apparatus may further include: a material storage unit disposed on the body unit; and a connection member connecting the material supply unit and the material storage unit.

A guide hole may be formed in the body unit, and may be formed to be long (elongated) to allow the connection member to pass therethrough.

The material storage unit may be one of a syringe, a chute, and a hopper.

The light emitting unit may include: a substrate having a plurality of electrodes; a light emitting diode (LED) chip mounted on the substrate; and one or more wires electrically connecting the electrodes and the LED chip.

The lens fabrication apparatus may further include: a holder fixing the substrate of the light emitting unit and the lens mold.

According to another aspect of the present invention, there is a lens fabrication method including: disposing a lens mold having a connection portion at one end thereof on a light emission surface of a light emitting unit; coupling a body unit of a vacuum forming unit to the connection portion of the lens mold; retracting a material supply unit provided within the body unit to separate the material supply unit from the connection portion, and connecting the connection portion and an air discharge portion within the body unit; discharging air from within the lens mold to the outside through the connection portion and the air discharge portion; moving the material supply unit forward to connect the material supply unit to the connection portion; injecting a material from the material supply unit through the connection portion to fill the interior of the lens mold; and hardening the material filling the interior of the lens mold.

The air discharging and material injecting may be performed through the single connection portion.

The connection portion and the body unit may be coupled by inserting the body unit into the connection portion.

The connection portion and the body unit may be coupled by inserting the connection portion into the air discharge portion.

A support connected to a rear portion of the material supply unit may be disposed on a belt rotating forwards and backwards, and as the material supply unit moves forwards or backwards according to an operation of the belt, one end portion of the material supply unit may be tightly attached to the connection portion or separated therefrom to thus shut or open the air discharge portion of the body unit.

The support may be a driving motor, and a shaft of the driving motor may be connected to a transfer screw provided within the material supply unit to inject a material of the material supply unit to the interior of the lens mold through the connection portion.

A cylindrical device may be disposed such that a rod thereof is connected to a rear portion of the material supply unit, and as the material supply unit moves forwards or backwards according to a forward or backward movement of the rod, one end portion of the material supply unit may be tightly attached to the connection portion or separated therefrom, to thus shut or open the air discharge portion of the body unit.

Excessively supplied material within the lens mold may be accommodated in an excess resin accommodation recess formed on the inner circumferential surface of the lens mold.

The air discharging operation may be automatically stopped when the degree of vacuum within the lens mold reaches a predetermined level.

The air discharging operation may be performed through a suction pump connected to the air discharge portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing an air suction operational state of a lens fabrication apparatus according to an embodiment of the present invention;

FIG. 2 is a cross-sectional view showing a material injection operational state of the lens fabrication apparatus according to an embodiment of the present invention;

FIG. 3 is a cross-sectional showing another example of a nozzle movement unit of the lens fabrication apparatus of FIG. 1;

FIG. 4 is a cross-sectional showing another example of a nozzle movement unit of the lens fabrication apparatus of FIG. 2;

FIG. 5 is a cross-sectional view showing an air suction operational state of a lens fabrication apparatus according to another embodiment of the present invention; and

FIG. 6 is a cross-sectional view showing a material injection operational state of the lens fabrication apparatus according to another embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

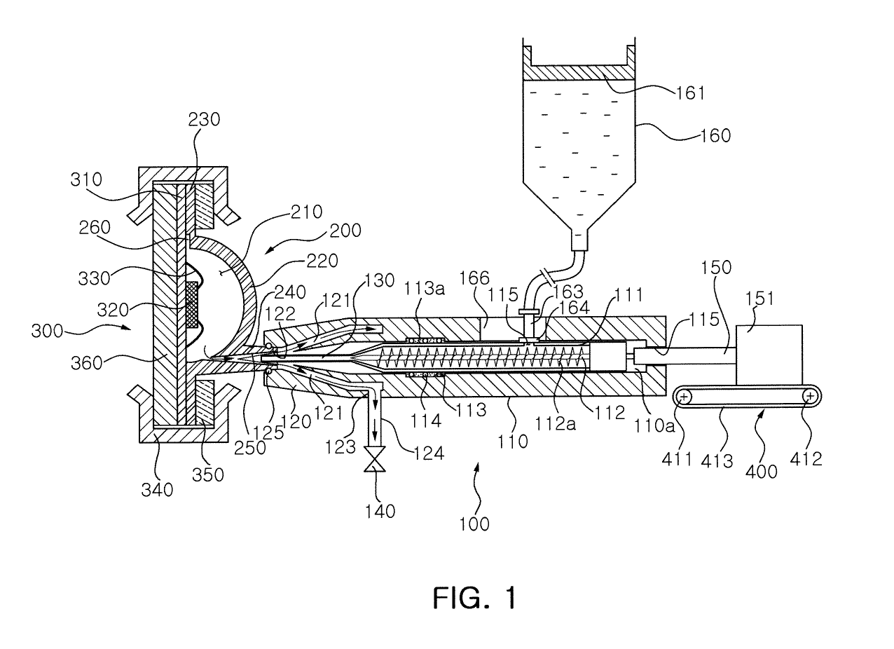

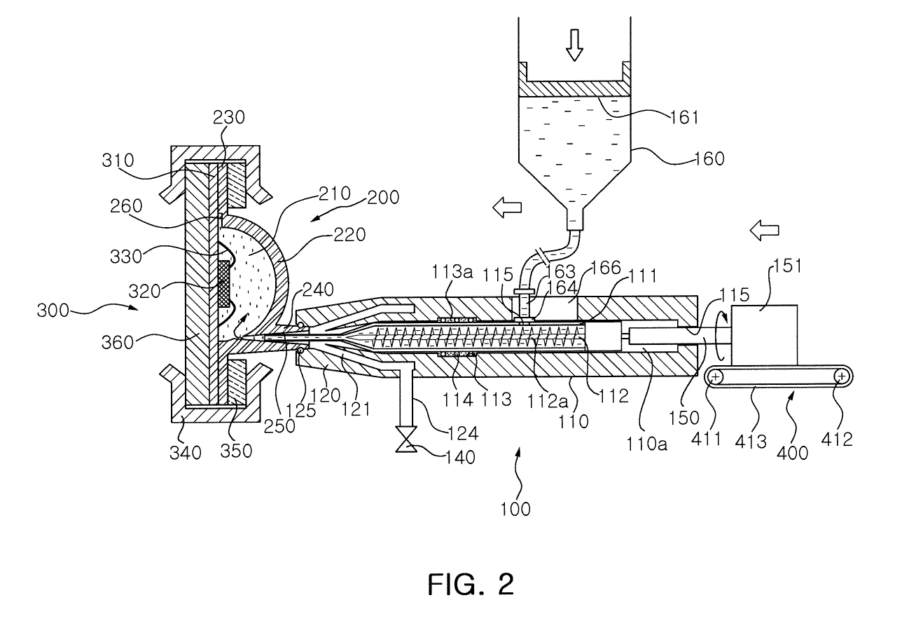

A lens fabrication apparatus according to an embodiment of the present invention will now be described with reference to FIGS. 1 and 2.

The lens fabrication apparatus according to an embodiment of the present invention includes a lens mold 200 having a connection portion 240 formed at one side thereof and disposed on a light emitting unit, and a vacuum forming unit 100 including a vacuum suction device discharging air within the lens mole 200 to the outside through the connection portion 240 and a material injection device injecting a material such as wax, a photocurable resin, or the like.

The vacuum forming unit 100 may include a body unit 110 having an air discharge portion 121 having one end communicating with the connection unit 240 and a material supply unit 111 installed within the body unit 110.

The light emitting unit may be a light emitting device package 300. The light emitting device package 300 may include a substrate 310, such as a PCB, or the like, having at least a pair of electrodes formed on one surface thereof, a light emitting diode (LED) chip 320 as a light source mounted on one face of the substrate 310, and one or more wires 330 electrically connecting the electrodes provided on the substrate 310 to the LED chip 320. Although not shown, the light emitting device package 300 may have a recess formed in the substrate 310 to have a cavity as necessary.

The lens mold 200 may include a central convex portion 220, and a flat portion 230 extending in a flat manner from a lower edge of the convex portion 220 to an outer side so as to be tightly attached to an upper portion of the substrate 310.

Here, the connection portion 240 may be protruded with a hollow portion 250 formed at one side of the convex portion 220, preferably, at an inner side of the convex portion 220, so as to communicate with the air discharge portion 121 of the vacuum forming unit 100 in a direction toward one end portion of the body unit 110.

A chamber 210 of the lens mold 200 is disposed on a light emission face of the light emitting device package 300. When the vacuum forming unit 100 operates as the vacuum suction device, internal air may be removed through the hollow portion 250 so as to be discharged to the outside. Also, when the vacuum forming unit 100 operates as the material injection device, a material may be injected into the interior thereof through the hollow portion 250. The injected material may form a lens covering the LED chip 320 and the wires 330 of the light emitting device package 300.

Here, a lens having a substantially hemispherical shape is formed according to the shape of the convex portion 220. Here, an inner circumferential surface of the convex portion 220 may be changed as necessary to fabricate lenses having various shapes.

Also, the lens mold 200 may be made of a transparent or translucent resin. Thus, when the vacuum forming unit 100 operates as the material injection device, a situation in which the material is injected into the chamber 210 may be simply determined. Also, whether or not air is captured in the lens simultaneously when the lens is formed can be determined.

The hollow portion 250 of the connection portion 240 may be configured to provide a sufficient space as an air discharge passage when an injection nozzle 130 of the vacuum forming unit 100 is separated. Also, when a material is injected into the chamber 210 of the material injection device, one end portion of the body unit 110 is completely tightly attached to an inner wall of the hollow portion 250. Meanwhile, the inner wall of the hollow portion 250 may be formed to be tapered such that a front portion thereof is wide and a rear portion thereof is narrow, to thus maintain airtightness with regard to the outside.

Meanwhile, the related art transfer molding technique, or the like, does not have a unit for handling a situation in which a material is excessively supplied to the interior of the lens mold. Thus, when the material is excessively supplied to the interior of the lens mold, the excessive amount of material is hardened as it is in a state of overflowing a portion adjacent to the portion to which the material of the lens mold is injected, generating a defective surface of the lens, or the like, and degrading stability of the operation.

However, according to the present embodiment, only one connection portion 240 of the lens mold 200 is provided on the convex portion 220. Namely, the hollow portion 250 of the single connection portion 240 plays both roles of discharging air and injecting a material therethrough.

In this case, when the amount of the material supplied to the chamber 210 is excessive, it may be difficult to handle the material excessively supplied to the interior of the chamber 210, so the excessively supplied material may flow backward into the vacuum forming unit 100, the material supply unit, through the hollow portion 250.

If the material is hardened while overflowing, a defect, such as a defective surface of the lens, or the like, may be generated. Thus, in the present embodiment, an excess resin accommodation recess 260 having a certain size to accommodate the excessively supplied material may be formed on an inner wall of the lens mold 200, preferably, in an inner circumferential surface of the flat portion 230.

Then, in supplying a material to the lens mold 200, the excessively supplied material can be prevented from being hardened in a state of overflowing the outer portion of the lens mold 200, whereby a defect such as a defective surface of the molded lens, or the like, can be reduced and operation stability can be enhanced.

Meanwhile, in the present embodiment, only one excess resin accommodation recess 260 is illustrated, but the present invention is not limited thereto, and two or more excessive resin accommodation recesses may be formed as necessary.

The lens mold 200 may be firmly fixed to the substrate 310 of the light emitting device package 300 so as not to be separated therefrom by using a holder 340. Preferably, the holder 340 may have a channel-like shape to vertically surround the circumference of the substrate 310 of the light emitting device package 300 and the flat portion 230 of the lens mold 200.

Here, an upper plate 350 and a lower plate 360 may be provided on an upper surface of the flat portion 230 of the lens mold 200 and a lower surface of the substrate 310 of the light emitting device package 300, respectively. The upper plate 350 and the lower plate 360 may be insertedly positioned between upper and lower inner faces of the holder 340 having a channel-like shape to maintain the fixed state of the lens mold 200 and the light emitting device package 300.

The vacuum forming unit 100 includes the body unit 110 having an accommodation space 110a formed in a lengthwise direction therein and a head part 120 provided at one end of the body unit 110 and having an air discharge portion connected with the accommodation space 110a therein.

The connection unit 240 of the lens mold 200 may be inserted into the air discharge portion of the head part 120 so as to be tightly coupled. Here, an O-ring 125 may be installed to be tightly attached to an inner circumferential surface of the head part 120 in order to block an air flow with the outside to enhance airtightness.

The material supply unit 111 may be installed in the accommodation space 110a such that it moves forward and backward in the accommodation space 110a. The interior of the material supply unit 111 is empty to allow a material for fabricating a lens to be filled therein, and the injection nozzle 130 may be provided at one end portion of the material supply unit 111 such that it is positioned on the air discharge portion 121 of the head part 120.

The air discharge portion 121 of the head part 120 may include an annular passage formed to be connected along an outer circumferential surface of the material supply unit 111 at an inner side of the head part 120, an entrance 122 connected with the hollow portion 250 of the connection portion 240 at a front side, an exit 123 formed on one portion of the body unit 120 and opened to the outside, and at least one connection passage connecting the entrance 122 and the annular passage.

The entrance 122 may be positioned on a virtually identical axis in a lengthwise direction as that of the injection nozzle 130 to allow the injection nozzle 130 to be inserted into the hollow portion 250 of the connection portion 240 through the entrance 122 when the injection nozzle moves forward and backward.

The exit 123 may be installed in the head portion 120 as necessary. A connection member 124 such as a tube, a pipe, or the like, may be installed on the exit 123, and a suction pump 140 may be provided at an end portion of the connection member 124 in order to provide suction force for sucking air from the interior of the chamber 210 of the lens mold 200.

A moving unit 400 may be provided at a rear side of the vacuum forming unit 100. The moving unit 400 moves the injection nozzle 130 forwards and backwards to switch the vacuum forming unit 100 from the vacuum suction device to the material injection device and vice versa.

With reference to the foregoing configuration, in the lens fabrication apparatus according to the present embodiment, the connection portion 240 of the lens mold 200 may be coupled in a state of being insertedly positioned in the entrance 122 of the air discharge portion 121. The injection nozzle 130 of the vacuum forming unit 100 may be installed to move forward and backward through the entrance 122 by means of the moving unit 400.

Accordingly, when the injection nozzle 140 retracts, to be spaced apart from the inner circumferential surface of the hollow portion 250 of the connection portion 240, the chamber 210 of the lens mold 200, the hollow portion 250, and the air discharge portion 121 communicate with each other, so air can be drawn into the chamber according to the operation of the suction pump 140 and discharged to the outside.

When the drawing of air through the suction pump 140 is completed and the degree of vacuum within the chamber 210 reaches a certain level, the moving unit 400 is operated to enable the injection nozzle 130 to move forward through the entrance 122.

Accordingly, the injection nozzle 130 is tightly attached to the inner circumferential surface of the hollow portion 250 of the connection portion 240 and the hollow portion 250 and the air discharge portion 121 are disconnected, and in this state, the material discharged from the injection nozzle 130 is injected into the interior of the chamber 210 through the hollow portion 250. The operation of the lens fabrication apparatus according to the present embodiment will be described in detail later in describing a lens fabrication method.

The material supply unit 111 may include a transfer screw 112 installed in the lengthwise direction therein to transfer the stored material toward the injection nozzle 130. The transfer screw 112 may include a plurality of blades 112a and be connected to a driving motor 151 installed at a rear side of the body unit 110 through a shaft 150. Reference numeral 115 denotes a through hole (or an input hole) allowing the shaft 150 to pass therethrough.

The driving motor 151 may be coupled with the moving unit 400 disposed at a rear side. The moving unit 400 includes a pair of rollers 411 and 412 disposed to be spaced apart from one another and a belt 413 installed to have both ends caught by rollers 411 and 412 so as to be rotatable. The driving motor 151 is disposed on the belt 413.

Thus, according to the forward and backward rotation of the belt 413, the driving motor 151 cooperatively moves forwards and backwards. Then, the shaft 150 connected with the driving motor 151, the material supply unit 111 connected with the shaft 150, and the injection nozzle 130 move forwards and backwards together. Accordingly, the end portion of the injection nozzle 130 is tightly attached to the inner wall of the hollow portion 250 of the connection portion 240 or separated from the inner wall of the hollow portion 250.

Meanwhile, in the present embodiment, the driving motor 151, the transfer screw 112, and the like, are illustrated as the moving unit 400 for transferring a material toward the injection nozzle 130. However, the present invention is not limited thereto, and the transfer unit may be variably substituted by a solenoid type or a cam type dispensing pump, or the like.

A long guide hole 166 may be formed in the lengthwise direction of the material supply unit 111 at an upper portion of the body unit 110. A syringe 160 may be installed above the guide hole 166 in order to temporarily store a material to facilitate supplying the material to the material supply 111.

A pressing plate 161 may be installed in an inner accommodation space of the syringe 160 in order to pressurize the stored material to discharge the material to the material supply unit 111 positioned at a lower side of the syringe 160. Here, the pressing plate 161 may be replaced by any member so long as it can supply the material accommodated in the accommodation space to the material supply unit 111.

Meanwhile, in the present embodiment, the syringe 160 is illustrated as a unit for storing the material, but the present invention is not limited thereto and the material storage unit may be variably replaced by a chute, a hopper, or the like. The syringe 160 has an accommodation space for accommodating resin therein. The syringe 160 is connected with the input hole 115 formed on one face (upper face in the drawings) of the material supply unit 111 through a connection member 163. In the present embodiment, a structure in which a plurality of pipes 163 are connected is illustrated as the connection member 163, but the present invention is not limited thereto and the connection member 163 may be variably replaced by a tube, a flexible tube, or the like, as necessary.

Here, the connection member 163 is positioned on the guide hole 166 of the body unit 110. The guide hole 166 allows the connection member 163 to be caught by a particular portion of the vacuum forming unit 100 to as to be prevented from moving when the material supply unit 111 moves forward and backward along the accommodation space 110a according to a forward and backward movement of the shaft 150.

Also, a protrusion piece 164 having a shape of, for example, a flange, may be formed at an end portion of the connection member 163 in order to seal a connection portion when the connection member 163 is coupled to the input hole 115 formed on the material supply unit 111. A sealing unit such as a packing, or the like, may be further installed at the protrusion piece 164 as necessary in order to enhance an airtightness effect.

One or more air inflow restricting recesses 113 may be formed in an inner circumferential surface of the accommodation space 110a of the body unit 110 in order to prevent communication with the air discharge portion 121 formed on the head part 120. Here, one or more O-rings 114 may be provided on an outer circumferential surface of the material supply unit 111 such that the O-rings 114 are tightly attached to the inner circumferential surface of the air inflow restricting recesses 113.

The O-rings 114 serve to prevent air introduced through the air discharge portion 121 from unexpectedly flowing into the accommodation space 110a of the body unit 110 when air is removed from the chamber 210. Here, the air inflow restricting recesses 113 may be filled with a lubricant having a high level of viscosity, such as grease, to form a lubricant layer 113a in order to minimize impact applied to the inner circumferential surface of the body unit 110 when the material supply unit 111 moves forwards and backwards, while maintaining airtightness.

Meanwhile, the lens fabrication apparatus according to the present embodiment may further include a controller (not shown) controlling operations of the suction pump 140, the moving unit 400, the driving motor 151, the pressing plate 161 of the syringe 160, and the like, to drive or stop them.

A lens fabrication method using the lens fabrication apparatus configured as described above according to an embodiment of the present invention will be described as follows. Here, for the sake of brevity, the left direction in the drawings will be referred to as a forward direction and the right direction in the drawing will be referred to as a backward direction.

First, the lens mold 200 is disposed on a surface of the substrate 310 of the light emitting device package 300 on which the LED chip 320 is mounted to form a chamber 210 at an inner side of the lens mold 200. Next, the connection portion 240 of the lens mold 200 is inserted into the entrance 122 of the air discharge portion 121 of the head part 120 to connect the hollow portion 250 of the connection portion 240 to the air discharge portion 121 of the head part 120.

And then, the moving unit 400 is driven to rotate the rollers 411 and 412 in a reverse direction. Then, the belt 413 rotates toward the rear according to the reverse directional rotation of the rollers 411 and 412, retreating the driving motor 151 disposed on the belt 413.

At this time, the shaft 150 connected to the driving motor 151 and the material supply unit 111 connected to the shaft 150 are retreated together, and accordingly, the injection nozzle 130 provided at a front end of the material supply unit 111 is also moved rearward.

Accordingly, the end portion of the injection nozzle 130 is separated from the inner circumferential surface of the hollow portion 250 provided at the connection portion 240 of the lens mold 200. Then, the entrance 122 of the air discharge portion 121 is opened, connecting the chamber 210 of the lens mold 200, the hollow portion 250, and the air discharge portion 121 of the head part 120, as a single passage.

Thereafter, when the suction pump 140 connected to the exit 123 of the air discharge portion 121 is operated, air filled within the chamber 210 of the lens mold 200 sequentially passes through the hollow portion 250 of the connection portion 240, the entrance 122 of the air discharge portion 121, the air discharge portion 121, the exit 123 of the air discharge portion 121, and the connection member 124, which are connected as a single passage, so as to be discharged to the outside. When air within the chamber 210 is quickly entirely discharged to the outside, defective molding of the lens when a material is filled can be minimized and operability can be enhanced.

In this case, the operations of the moving unit 400 and the suction pump 140 may be controlled by the controller. Also, preferably, when the degree of vacuum within the chamber 210 reaches a certain level, the controller may automatically stop the air suction operation, thus enhancing operational stability as well as shortening an operation time.

When air within the chamber 210 is entirely removed and the degree of vacuum within the chamber 210 reaches a certain level, the moving unit 400 is driven in the opposite direction by the controller.

Then, the rollers 411 and 412 are rotated in the forward direction, i.e., the direction opposite to that of the previous operation, the belt 413 is rotated to the front side according to the forward directional rotation of the rollers 411 and 412, and the driving motor 151 disposed on the belt 413 cooperatively moves forward to be returned to the initial position.

Then, the shaft 150 connected to the driving motor 151 and the material supply unit 111 connected to the shaft 150 move forward together, and the injection nozzle 130 provided at one end of the material supply unit 111 is moved together to the front side.

Then, the end portion of the injection nozzle 130 is inserted into the hollow portion 250 formed at the connection portion 240 of the lens mold 200 and tightly attached to the inner circumferential surface of the hollow portion 250. Accordingly, the entrance 122 of the air discharge portion 121 is stopped by the injection nozzle 130, and the hollow portion 250 of the connection portion 240 and the air discharge portion 121 of the head part 120 is disconnected. Accordingly, the vacuum state within the chamber 210 is maintained.

Thereafter, when the pressing plate 161 provided in the accommodation space formed within the syringe 160 is lowered, the stored material is supplied to the material supply unit 111 of the injection unit 100 through the pipe 163.

In this state, when the driving motor 151 is operated, the shaft 150 of the driving motor 151 and the transfer screw 112 connected to the shaft 150 are rotated to transfer the material stored in the material supply unit 111 toward the injection nozzle 130.

The material transferred to the injection nozzle is discharged through the injection nozzle 130 and introduced into the chamber 210 formed by the lens mole 200 through the hollow portion 250 of the connection portion 240 to fill the chamber 210 in the shape of a lens, i.e., the shape of the inner circumferential surface of the convex portion 210.

Thereafter, when the material injection is completed, the moving unit 400 is again driven in the reverse direction to move the injection nozzle 130 to the rear side, separating the injection nozzle 130 from the hollow portion 250 of the connection portion 240.

Here, the material remaining after having been supplied to the interior of the chamber 210 is accommodated in the resin accommodation recess 260 formed in the inner circumferential surface of the lens mold 200, thus preventing the excessively supplied material from flowing back toward the vacuum forming unit 100.

Thereafter, the vacuum forming unit 100 is entirely moved to the rear side to completely separate the head part 120 from the connection portion 240. And then, the resin filled within the chamber 210 of the lens mold 200 is hardened. Thereafter, the coupling state of the holder 340 is released, and the lens mold 200 is separated from the substrate 310, thereby completing the light emitting device package 300 having a high-quality lens formed on the light emission surface on which the LED chip 320 is installed.

Meanwhile, in the present embodiment, the rollers 411 and 412 having a shape of a rail and the belt 413 are illustrated as the moving unit 400, but the present invention is not limited thereto.

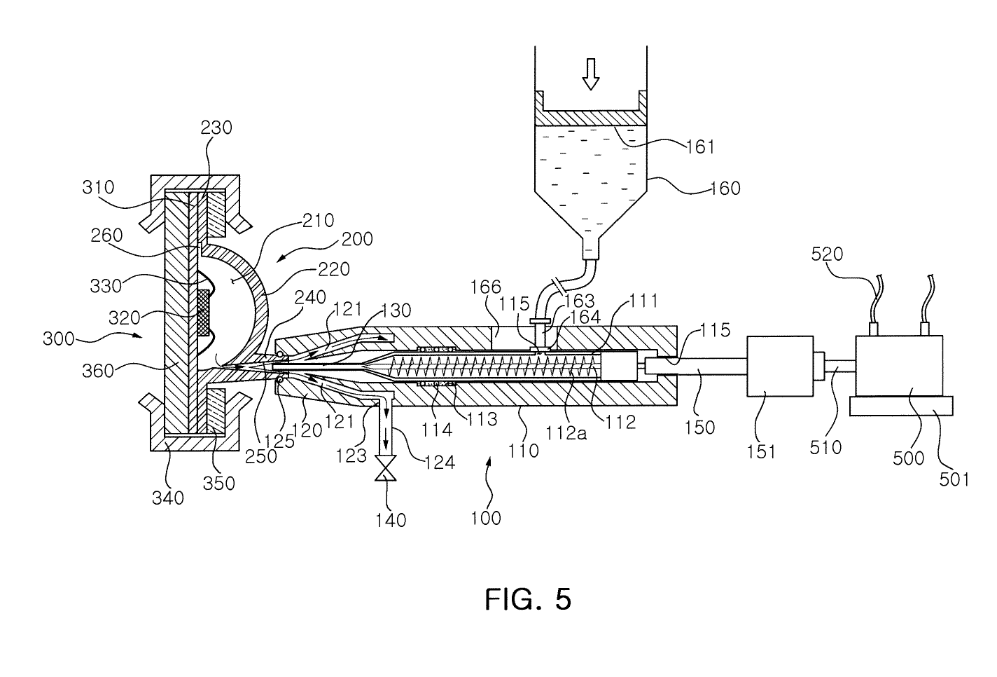

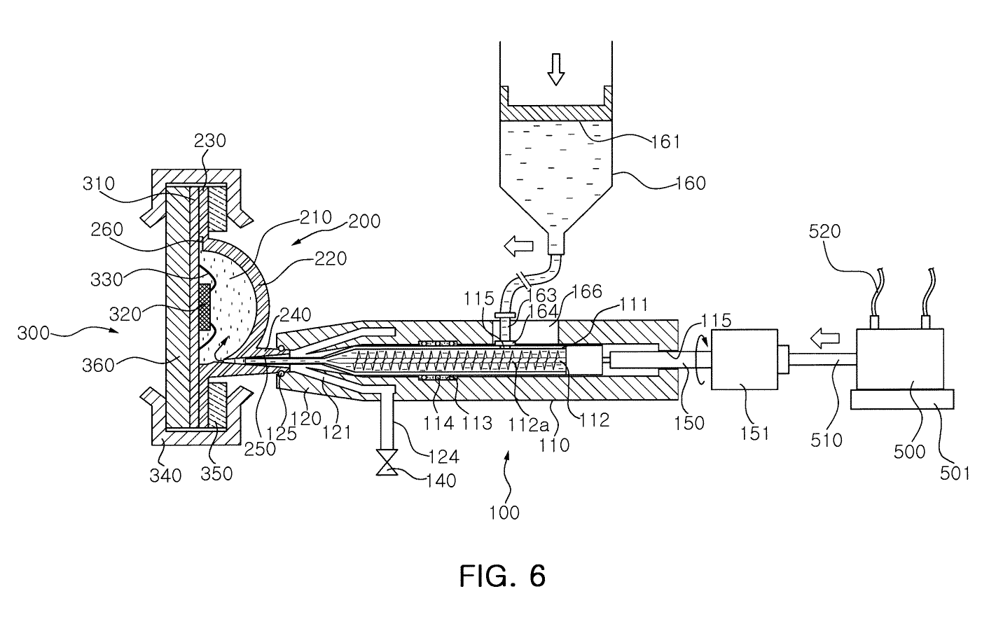

For example, as shown in FIGS. 5 and 6, a cylindrical device 500 fixedly installed on a support plate 501 may be configured as a moving unit. The cylindrical device 500 includes a rod 510 connected to a rear portion of the driving motor 151 and one or more hydraulic tubes 520 formed at one portion thereof and connected to a compressor, or the like. The cylindrical device 500 moves the rod 510 forward and backward upon receiving a fluid through the hydraulic tubes 520, thus moving the driving motor 151 forwards and backwards.

Thus, as the driving motor 151 moves forwards and backwards according to the forward and backward movement of the rod 510, the shaft 152 connected to the driving motor 151 and the material supply unit 111 connected to the shaft 152 and the injection nozzle 130 move forwards and backwards.

Then, the end portion of the injection nozzle 130 is tightly attached to the inner circumferential surface of the hollow portion 250 provided at the inner side of the connection portion 240 or separated from the inner circumferential surface of the hollow portion 250, thus opening the connection state between the hollow portion 250 and the air discharge portion 121. Other components are the same as those of the former embodiment, so a detailed description thereof will be omitted.

In an embodiment of the present invention, the connection portion 240 of the lens mold 200 is inserted into the entrance 122 of the air discharge portion 121 formed at the inner side of the head part 120 so as to be tightly coupled on the inner circumferential surface thereof. However, the present invention is not necessarily limited to such a structure.

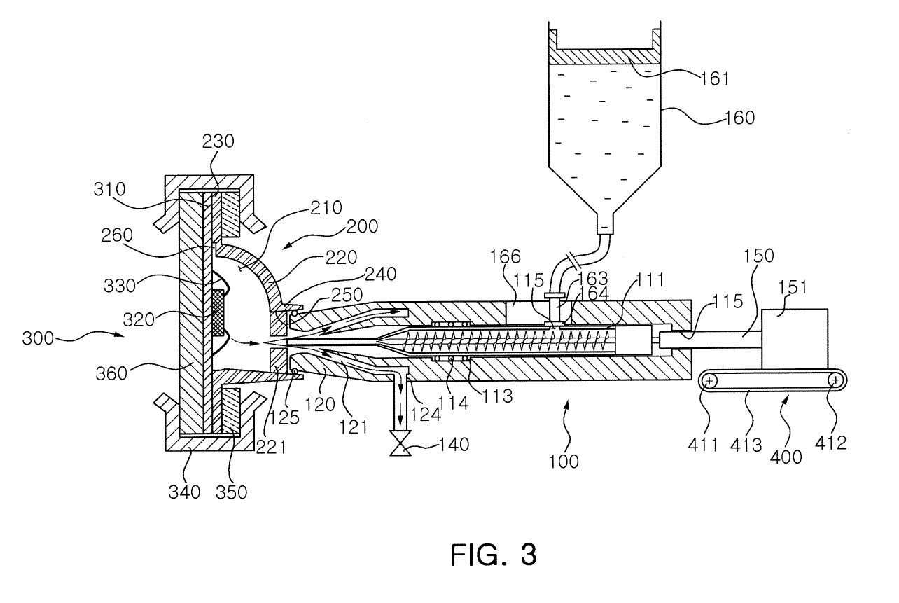

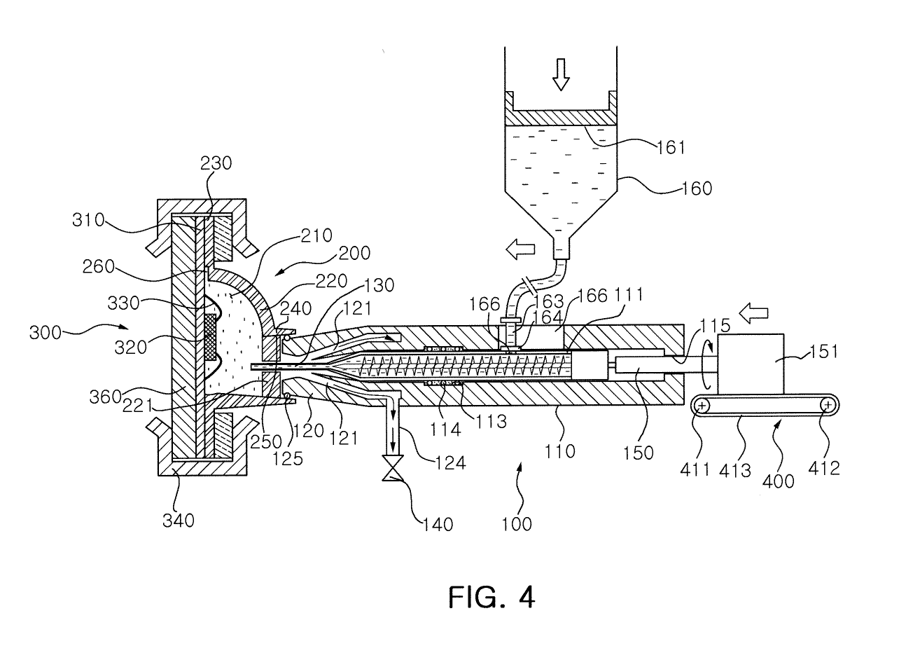

For example, as shown in FIGS. 3 and 4, in a coupling structure between the lens mold 200 and the vacuum forming unit 100 according to an embodiment of the present invention, the entrance 122 of the air discharge portion 121 of the head part 120 may be inserted into the hollow portion 250 formed at an inner side of the connection portion 240 of the lens mold 220 so as to be tightly coupled to the inner circumferential surface of the hollow portion 250.

When the head part 120 is inserted into the inner side of the connection portion 240, the O-ring 125 for airtightness with regard to the outside may be installed on an outer circumferential surface of the head part 120 so as to be tightly attached to the inner circumferential surface of the connection portion 240.

Here, a blocking piece 221 may be formed on the inner circumferential surface of the connection portion 240 to block spaces other than a hole having a certain size allowing the injection nozzle 130 to pass therethrough to thus enhance air suction and a material injection effect. Other components are the same as those of the former embodiment, so a detailed description thereof will be omitted.

As set forth above, according to embodiments of the invention, since the air suction part and the material injection part of the lens mold are integrally formed, thus reducing fabrication time, fabrication costs, and required facility space.

In addition, before a material is supplied to the interior of the chamber of the lens mold, air within the chamber is completely discharged to vacuumize the interior of the chamber to a maximum level thereof, whereby the dimensional accuracy of the lens shape is enhanced, generation of voids in the lens is prevented, thus fabricating a high-quality lens having enhanced light uniformity and light efficiency.

While the present invention has been shown and described in connection with the embodiments, it will be apparent to those skilled in the art that modifications and variations can be made without departing from the spirit and scope of the invention as defined by the appended claims.

What is claimed is:

1. A lens fabrication apparatus comprising:
a lens mold having a connection portion formed on one side thereof and disposed on a light emission surface of a light emitting unit; and
a vacuum forming unit discharging air from within the lens mold to the outside through the connection portion or injecting a material into the lens mold through the connection portion.

2. The apparatus of claim 1, wherein one connection portion is provided.

3. The apparatus of claim 1, wherein the vacuum forming unit comprises:
a body unit having an air discharge portion with one end communicating with the connection portion; and
a material supply unit installed within the body unit.

4. The apparatus of claim 3, wherein the air discharge portion is an air passage formed within the body unit, and an entrance communicating with the connection portion and at least one exit opened to the outer side of the body unit may be provided at both ends of the air passage.

5. The apparatus of claim 4, wherein the air passage comprises:
an annular passage having the exit and formed between an inner circumferential surface of the body unit and an outer circumferential surface of the material supply unit; and
at least one connection passage connecting the entrance and the annular passage.

6. The apparatus of claim 3, wherein the connection portion is a protrusion having a hollow portion, and the protrusion is inserted into the air discharge portion to be coupled thereto.

7. The apparatus of claim 6, wherein an O-ring is installed on an outer circumferential surface of the protrusion.

8. The apparatus of claim 3, wherein the connection portion is a protrusion having a hollow portion, and one end portion of the body unit is inserted into the hollow portion to be coupled thereto.

9. The apparatus of claim 8, wherein an O-ring is installed on an outer circumferential surface of the one end portion of the body unit.

10. The apparatus of claim 6, wherein the hollow portion of the connection portion is formed to be tapered.

11. The apparatus of claim 8, wherein the hollow portion of the connection portion is formed to be tapered.

12. The apparatus of claim 3, further comprising a moving unit moving the material supply unit to connect the material supply unit to the connection portion.

13. The apparatus of claim 12, wherein the moving unit comprises:
a pair of rollers disposed to be spaced apart at a rear side of the material supply unit;
a belt installed to be rotatable by the pair of rollers; and
a support having one end connected with the material supply unit and disposed on the belt.

14. The apparatus of claim 13, wherein the support is a driving motor, and a transfer screw is provided within the material supply unit such that the transfer screw is connected to a shaft of the driving motor.

15. The apparatus of claim 12, wherein the moving unit is a cylindrical device having a rod with one end connected with a rear portion of the material supply unit.

16. The apparatus of claim 1, wherein the lens mold comprises:
a central convex portion; and
a flat portion formed in the circumferential surface of a lower end of the convex portion.

17. The apparatus of claim 1, wherein at least one excessive material accommodation recess is formed in an inner circumferential surface of the lens mold.

18. The apparatus of claim 3, further comprising a suction pump connected to the air discharge portion.

19. The apparatus of claim 18, wherein the air discharge portion and the suction pump are connected by a connection member.

20. The apparatus of claim 3, further comprising:
at least one air inflow restricting recess formed in an inner circumferential surface of the body unit; and
at least one O-ring installed on an outer circumferential surface of the material supply unit at a position of the air inflow restricting recess.

21. The apparatus of claim 20, wherein a lubricant layer is provided in the air inflow restricting recess.

22. The apparatus of claim 3, further comprising:
a material storage unit disposed on the body unit; and
a connection member connecting the material supply unit and the material storage unit.

23. The apparatus of claim 22, wherein a guide hole is formed in the body unit, and is formed to be elongated to allow the connection member to pass therethrough.

24. The apparatus of claim 22, wherein the material storage unit is one of a syringe, a chute and a hopper.

25. The apparatus of claim 1, wherein the light emitting unit comprises:
a substrate having a plurality of electrodes;
a light emitting diode (LED) chip mounted on the substrate; and
one or more wires electrically connecting the electrodes and the LED chip.

26. The apparatus of claim 25, further comprising a holder fixing the substrate of the light emitting unit and the lens mold.

27. A lens fabrication method comprising:
disposing a lens mold having a connection portion at one end thereof on a light emission surface of a light emitting unit;
coupling a body unit of a vacuum forming unit to the connection portion of the lens mold;
retracting a material supply unit provided within the body unit to separate the material supply unit from the connection portion, and connecting the connection portion and an air discharge portion within the body unit;
discharging air from within the lens mold to the outside through the connection portion and the air discharge portion;
moving the material supply unit forward to connect the material supply unit to the connection portion;
injecting a material from the material supply unit through the connection portion to fill the interior of the lens mold; and
hardening the material filling the interior of the lens mold.

28. The method of claim 27, wherein the air discharging and material injecting are performed through the single connection portion.

29. The method of claim 27, wherein the connection portion and the body unit are coupled by inserting the body unit into the connection portion.

30. The method of claim 27, wherein the connection portion and the body unit are coupled by inserting the connection portion into the air discharge portion.

31. The method of claim 27, wherein a support connected to a rear portion of the material supply unit is disposed on a belt rotating forwards and backwards, and as the material supply unit moves forwards or backwards according to an operation of the belt, one end portion of the material supply unit is attached to the connection portion or separated therefrom to thus shut or open the air discharge portion of the body unit.

32. The method of claim 31, wherein the support is a driving motor, and a shaft of the driving motor is connected to a transfer screw provided within the material supply unit to inject a material of the material supply unit to the interior of the lens mold through the connection portion.

33. The method of claim 27, wherein a cylindrical device is disposed such that a rod thereof is connected to a rear portion of the material supply unit, and as the material supply unit moves forwards or backwards according to a forward or backward movement of the rod, one end portion of the material supply unit is attached to the connection portion or separated therefrom, to thus shut or open the air discharge portion of the body unit.

34. The method of claim 31, wherein excessively supplied material within the lens mold is accommodated in an excess resin accommodation recess formed on the inner circumferential surface of the lens mold.

35. The method of claim 27, wherein the air discharging operation may be automatically stopped when the degree of vacuum within the lens mold reaches a predetermined level.

36. The method of claim 27, wherein the air discharging operation is performed through a suction pump connected to the air discharge portion.
